(19) United States
(12) Patent Application Publication
(10) Pub. No.: US 2021/0245310 A1
(43) Pub. Date: Aug. 12, 2021

(54) METHOD FOR PRODUCING A HEAT PIPE

(71) Applicant: Miba Sinter Austria GmbH, Laakirchen (AT)

(72) Inventors: Philipp PICHLER, Thalheim bei Wels (AT); Franz-Josef GIELESBERGER, Ohlsdorf (AT); Samuel WALLNER, Ligist (AT); David KOCJAN, Trzisce (SI)

(73) Assignee: Miba Sinter Austria GmbH, Laakirchen (AT)

(21) Appl. No.: 17/166,044

(22) Filed: Feb. 3, 2021

(30) Foreign Application Priority Data
Feb. 12, 2020 (AT) A50105/2020

(51) Int. Cl. B23P 15/26; F28D 15/04

(52) U.S. Cl. CPC B23P 15/26; B23P 2700/09; F28D 15/04

(57) ABSTRACT

A method for producing a heat pipe includes the steps: providing a casing element; arranging a coherent capillary structure on the casing element; and connecting the capillary structure to the casing element.

The invention relates to a method for producing a heat pipe comprising the steps: providing a casing element and arranging a coherent capillary structure on the casing element.

The invention further relates to a heat pipe comprising a casing element and a coherent capillary structure which is surrounded by the casing element.

Heat pipes have been described in manifold ways in the prior art. In simple terms, a heat pipe is a self-contained system in a substantially pipe-shaped housing that has a fluid in its inside that is close to its boiling point at operating temperature due to the prevailing pressure. If the heat pipe is heated in a partial area, the fluid changes to the gaseous phase, to flow in the direction of a cooler area in the interior of the heat pipe, condense there and flow back into the warmer area along the inner walls of the housing of the heat pipe. In the course of this (heat) transport process, the heat pipe extracts heat from its surroundings in an evaporation area and supplies this heat to the surroundings of the condensation area of the heat pipe.

For transporting the liquid fluid from the condensation area into the evaporation area, capillary structures can be provided in such heat pipes. These can be generated using diverse means. Inter alia, metal networks and/or metal grids are used which are inserted into the heat pipes.

The present invention is based on the object of improving the applicability of such heat pipes.

The object of the invention is achieved by the initially mentioned method according to which it is provided that the capillary structure is connected to the casing element.

The object of the invention is further achieved by the initially mentioned heat pipe in which the capillary structure is connected to the casing element.

The advantage of this is that by connecting the capillary structure to the casing element, the capillary structure cannot slip any more. Hence, a space not provided with the capillary structure can be provided in the interior of the heat pipe, in which the vapor phase can flow with a lower resistance. In this regard, detachment of the capillary structure can be prevented by the connection of the capillary structure with the casing element. The detachment would reduce the efficiency of the heat pipe by reducing the heat entering the heat pipe. This is due to fact that by the detachment, the heat conduction from the casing element into the capillary structure is omitted such that the heat is brought into the capillary structure merely by convection in the interior of the heat pipe. In case of partial detachment of the capillary structure, there still is a heat conduction share from the casing element into the capillary structure. However, this share is also reduced since the contact surface between the casing element and the capillary structure are reduced due to the detachment. In addition to this, the return flow of the condensed working fluid to the heat source along the casing element is impeded or interrupted. To cope with this, the prior art presents solutions according to which the entire interior is filled with the capillary structure. However, thereby, the flow cross section in the inside of the heat pipe is additionally narrowed, which allows a smaller amount of gas to be transported to the condensation chamber. Complete filling of the interior of the casing element is not required according to the invention, such that the capillary structure can also be designed relatively thin.

According to an embodiment variant of the invention, it can be provided that a metal net or a metal mesh or a metal sponge or a metal wool or a metal foam is used as the capillary structure. These capillary structures can particularly easily be connected to the casing element since a relatively large proportion of the surface can be provided for the connection area. Moreover, at least a part of these capillary structures has a good inherent stiffness, which supports the prevention of detachment of the capillary structure from the casing element.

According to a further preferred embodiment variant of the invention, it can be provided that the connection between the casing element and the capillary structure is established by sintering. The establishment of the connection can hence be carried out relatively easily by the casing element provided with the capillary structure being subjected to the sintering temperature. A manipulation in the inside of the capillary structure is thus not required for forming the connection. Moreover, by sintering, changes in the materials caused by melting metallurgy and the associated changes in properties can be avoided at least largely.

According to a further embodiment variant of the invention, it can be provided that the capillary structure has a length and is connected to the casing element across the entire length. Hence, the formability of the heat pipe can be improved without the capillary structure partially detaching from the casing element due to the forming, e.g. bending. The formability of the heat pipe is in fact improved in the aforementioned embodiment variant as compared to heat pipe designs without a connection between a coherent capillary structure and the casing element; however, by the formability or deformability in this embodiment variant of the invention, it is further improved.

According to another embodiment variant of the invention, it can be provided that, in the casing element, prior to connecting the capillary structure to the casing element, at least one spring element is arranged such that the capillary structure is arranged between the casing element and the spring element. By means of the at least one spring element, the capillary structure can be “preloaded” against the casing element prior to connecting. Hence, heat pipes with larger diameters can also be produced relatively easily.

According to an embodiment variant of the invention, a coil spring can be used as the spring element for this purpose. Due to the complete contact of the spring element with the capillary structure, this entails the advantage of a good contact of the capillary structure with the casing element with a relatively easy insertability of the spring element into the inside of the casing element.

According to a further embodiment variant of the invention, it can be provided that a metal pipe is used as the casing element from the outset or that the casing element is formed into a pipe after establishment of the connection to the capillary structure. By using a pipe, subsequent processing steps can be reduced which allows for a reduction of the impact onto the capillary structure. The subsequent formation to a pipe, in turn, has the advantage of the easier insertability of the capillary structure, which allows for heat pipes with very small diameters being produced more easily.

For the purpose of better understanding of the invention, it will be elucidated in more detail by means of the figures below.

These show in a respectively very simplified schematic representation:

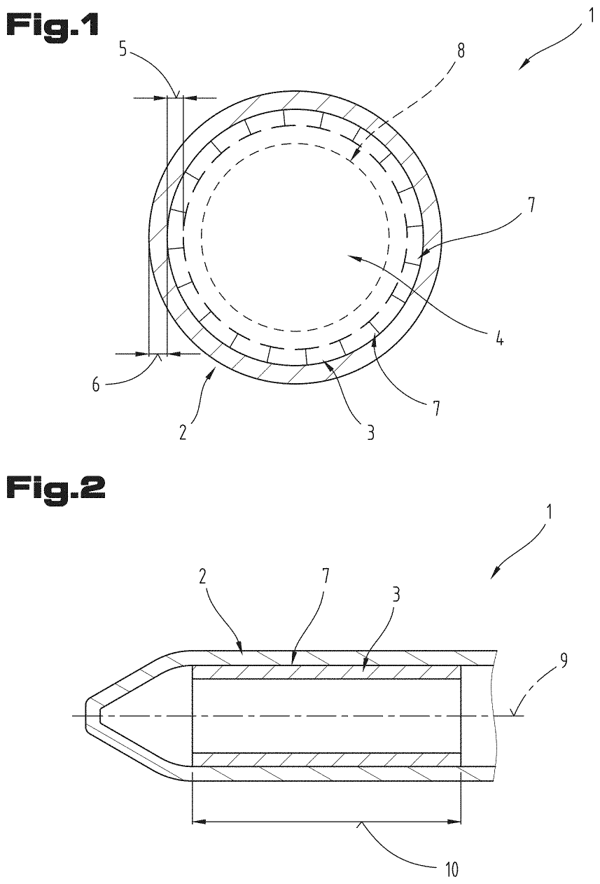

FIG. 1 a heat pipe in cross section;

FIG. 2 a heat pipe in longitudinal section;

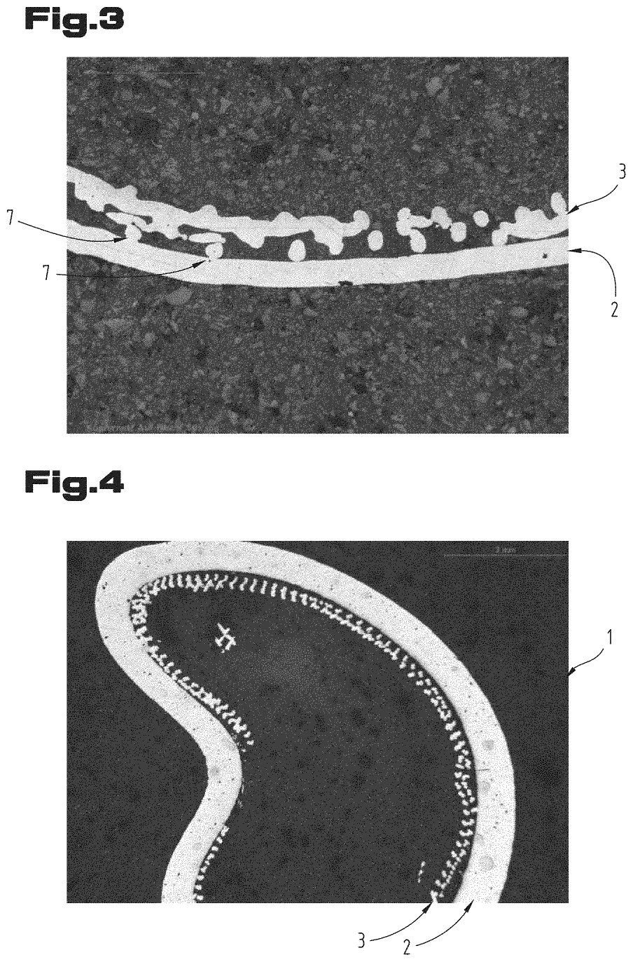

FIG. 3 a microscope image of a section of a heat pipe;

FIG. 4 a microscope image of a section of a deformed heat pipe with a sintered mesh as capillary structure.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a cross section through a heat pipe 1.

The heat pipe 1 serves for cooling and/or tempering objects. It can be generally be used for heat transport, to transport heat energy from a first location to a second location. The functionality has already been briefly elucidated above.

The heat pipe 1 comprises a casing element 2 and a capillary structure 3 (which can also be referred to as capillary element) and/or consists of these components.

The casing element 2 is formed as a pipe. It can have diverse cross sections, such as circular, oval, polygonal, or square, rectangular, and so on. According, the shape of the heat pipe 1 and/or of the casing element 2 shown in the Figures is not to be understood in a limiting manner.

The casing element 2 consists of a metal material. Preferably, copper or a copper-based alloy is used because of its thermal conductivity. However, other metals or metal alloys, such as aluminum, silver, etc., can also be used. The used material also provided the heat pipe 1 with the dimensional stability in the temperature range used.

The capillary structure 3 also consists of or comprises a metal material. Preferably, copper or a copper-based alloy is used because of its thermal conductivity. However, other metals or metal alloys, such as aluminum, silver, steel etc., can also be used. The capillary structure represents the capillaries for transporting the liquid working medium in the heat pipe 1.

The capillary structure 3 is coherent. Within the meaning of the present description, the term “coherent” is to be understood such that the capillary structure is not powdery or particulate and does not consist of a sintered powder. In other words, thus, a capillary structure 3 is addressed which forms a coherent structure already before a sintering process, and which has been produced without a sinter process (for instance by punching, weaving etc.). The material itself, of which the coherent capillary structure is made, is not a sintering material but a solid material.

In the preferred embodiment variant of the heat pipe 1, the capillary structure 3 is a metal net or a metal mesh or a metal sponge or a metal wool or a metal foam and/or a metal net or a metal mesh or a metal sponge or a metal wool or a metal foam is used for producing the heat pipe 1. In this context, it is also possible that multiple layers of metal nets or metal meshes are arranged lying on top of one another.

The casing element 2 defines an interior 4 which it encloses. The capillary structure 3 is arranged in this interior 4 and is accordingly also enclosed by the casing element 2.

The capillary structure 3 can have a layer thickness 5 which corresponds to between 1% and 1000% of a wall thickness 6 of the casing element 2.

Further, the layer thickness 5 of the capillary structure 3 can have a value amounting to between 0.1% and 50% of the largest dimension of the cross section of the interior 4. In the shown embodiment variant of the heat pipe 1, this is the diameter of the interior 4. In flat heat pipes 1 the cross section of which has a width and a height, this is the width of the interior 4.

It is provided that the capillary structure 3 is or is intended to be connected to the casing element 2. For this purpose, the casing element 2 is provided and the capillary structure 3 is arranged on and/or in the casing element 2.

In principle, any suitable connecting method can be applied for connecting the capillary structure 3 to the casing element 2, as long as the connection remains stable at the use temperature of the heat pipe 1, i.e. the connection is not destroyed during normal use of the heat pipe 1. However, the capillary structure 3 is preferably connected to the casing element 2 by material bonding. For example, the capillary structure 3 can be glued or welded to the casing element 2. In the preferred embodiment variant of the invention, the capillary structure 3 is sintered to the casing element. For this purpose, the casing element 2 equipped with the capillary structure 3 can be subjected to an increased temperature (the sintering temperature) for a certain period of time (e.g. between 5 minutes and 155 hours), for instance in a continuous furnace. In this regard, this temperature is governed by the used metal materials and can be between 300° C. and 1,500° C., in particular between 700° C. and 1,300° C. Since sintering methods are per se known, a further explanation can be dispensed with at this point.

In the sintering furnace, a protective gas atmosphere or reducing atmosphere may prevail to prevent oxidation of the metals.

Other heat sources can also be used for sintering. For example, the sintering can be carried out inductively. For this purpose, an inductor can be moved along the joint and/or brought up to the joint. Hence, it is possible to selectively connect (annular) sections only. In the alternative, it is also possible to move a pipe-shaped casing element 2 with a capillary structure 3 arranged on the inside through an (annular) inductor.

By the sintering, an outer ply or layer of the capillary structure 3, which is opposite to the casing element 2, is connected to the casing element 2, as is adumbrated in FIG. 1 in the connection areas 7. Thus, it is not obligatory for the entire net or mesh (if a metal net or metal mesh is used as the capillary structure) to be connected to the casing element 2, but merely discrete areas are sintered to it, for example one wire layer, as can be seen from FIG. 3. When a metal sponge is used as the capillary structure 3, for example the outer webs bonding pores of the metal sponge can be connected to the casing element 2.

To produce heat pipes 1 with larger diameters (for instance starting from 1 mm), it can be advantageous if, for connecting the capillary structure 3 to the casing element 2, according to an embodiment variant of the invention the capillary structure 3 is placed on the surface of the casing element 2 with at least one spring element 8, such that the capillary structure 3 does not slip any more when the casing element 2 with the capillary structure 3 is manipulated. The at least one spring element 8 is adumbrated in dashed lines in FIG. 1. It is arranged such in the casing element 2, that the capillary structure 3 is located between the casing element 2 and the at least one spring element 8.

However, the arrangement of at least one spring element can be advantageous also for heat pipes 1 with a smaller diameter if the capillary structure 3 does not have a sufficient inherent stiffness, for example when a single-layer, thin metal net is used as the capillary structure 3.

For example, an annular spring or a flat spring can be used as the spring element 8. However, according to a further embodiment variant, a coil spring is used preferably.

The at least one spring element 8 is preferably also made of a metal material, for example copper or a spring steel, and remains in the heat pipe 1.

To fix the position of the capillary structure 3 prior to connecting it to the casing element 2, a holding element, which is for example designed as a holding clip and can be put on projecting beyond the axial end faces of the holding element, can be used in place of or in addition to the at least one spring element 8. In this case, the capillary structure 3 is also arranged between the at least one holding element and the casing element 2. Optionally, the at least one holding element can be removed from the casing element 2 before it is filled with the heat transfer fluid and is sealed liquid-tight. However, it can also be left in the finished heat pipe 1.

FIG. 2 shows an embodiment variant of the heat pipe 1 in a longitudinal section. One end region is already sealed liquid-tight, the other end region of the pipe is still open.

As can be seen from FIG. 2, the capillary structure 3 has a total length 10 in the direction of a longitudinal central axis 9 through the heat pipe 1. In this embodiment variant, it is provided that the capillary structure is connected to the casing element 2 across the total width 10. Thus, connection areas 7 (in the aforementioned sense) are formed across the entire length of the capillary structure 3. This does not mean that the capillary structure 3 is connected to the casing element 2 on its full surface across the total length 10. However, in this embodiment variant, at least 90%, in particular at least 95%, of the contact surface(s) of the capillary structure 3 on the casing element 2 are connected thereto (in particular by material bonding).

Although this design of connection areas 7 distributed across the total length 10 is preferred (since it can be easily produced by a sintering process), it is also possible in the scope of the invention that multiple discrete connection zones are formed distributed across the total length 10, for example annular connection zones. For example, the beginning and end regions of the capillary structure 3 can be connected to the casing element 2. Moreover, further connection zones can be formed between the beginning and end regions of the capillary structure 3. In this regard, it is advantageous for a distance between the individual connection zones and/or connection areas 7 to amount to a maximum of 5% of the total length 10 of the capillary structure 3. For example, this distance can be selected from a range of 0.01% to 4%, preferably from a range of 0.1% to 2% of the total length 10 of the capillary structure 3.

According to a further embodiment variant, the inner surface of the casing element 2, i.e. the surface of the casing element 2 that faces the capillary structure, can be provided with a surface structure, in particular a gouge structure with gouges extending in the direction of the longitudinal central axis 9.

Preferably, an already pipe-shaped casing element 2, into which the capillary structure 3 and optionally the at least one spring element 8 is/are inserted, is used for producing the heat pipe 1. However, according to another embodiment variant of the invention, it can also be provided that the capillary structure 3 is placed on a casing element 2 which is, in particular, flat, and is connected to the casing element 2 in this state. The heat pipe 1 can be formed only after establishing this connection by forming the flat casing element 2 with the capillary structure 3, wherein, in this case, the open lateral end faces are also connected to one another in a liquid-tight manner (i.e. not only the beginning and end regions of the pipe). For easier formability, the casing element 2 can be pre-formed, i.e. already provided with a curvature, in this embodiment as well. However, it is preferably not yet entirely formed to a pipe.

By connecting the capillary structure 3 to the casing element 2, detachment of the capillary structure 3 can be prevented when forming the heat pipe 1. Moreover, it could be observed that hence the efficiency of the heat pipe 1 could be increased by approx. 10% to 15% (as compared to heat pipes of the same type but without a connection of the capillary structure to the casing element).

In the course of the tests carried out with the heat pipe 1, the images according to FIGS. 3 and 4 were made. For this purpose, a net of pure copper with a wire strength of 0.05 mm and a mesh opening of 300 μm was inserted in two layers as the capillary structure 3 into a copper pipe as the casing element 2. Subsequently, the capillary structure 3 was sintered to the casing element 2 at a temperature of 900° C. for a period of 120 minutes. The result of this process is shown in FIG. 3. The connection areas 7 formed between the inner surface of the casing element 2 and the capillary structure 3 can be seen clearly. These connections are practically not loosened even when the heat pipe 1 is strongly deformed, as shown in FIG. 4 which shows the heat pipe 1 after a corresponding formation. This heat pipe 1 had a circular cross section prior to forming.

The exemplary embodiments show possible embodiment variants, while it should be noted at this point that combinations of the individual embodiment variants are also possible.

Finally, as a matter of form, it should be noted that for ease of understanding of the structure of the heat pipe 1, it is not obligatorily depicted to scale.

### LIST OF REFERENCE NUMBERS

1 heat pipe

2 casing element

3 capillary structure

4 interior

5 layer thickness

6 wall thickness

7 connection area

8 spring element

9 longitudinal central axis

10 total length

1. A method for producing a heat pipe (1) comprising the steps:
providing a casing element (2);
arranging a coherent capillary structure (3) on the casing element (2);
wherein the capillary structure (3) is connected to the casing element (2).

2. The method according to claim 1, wherein a metal net or a metal mesh or a metal sponge or a metal wool or a metal foam is used as the capillary structure (3).

3. The method according to claim 1, wherein the connection between the casing element (2) and the capillary structure (3) is established by sintering.

4. The method according to claim 1, wherein the capillary structure (3) has a total length (10) and is connected to the casing element (2) across the total length (10).

5. The method according to claim 1, wherein, in the casing element (2), prior to connecting the capillary structure (3) to the casing element (2), at least one spring element (8) is arranged such that the capillary structure (3) is arranged between the casing element (2) and the spring element (8).

6. The method according to claim 5, wherein a coil spring is used as the spring element (8).

7. The method according to claim 1, wherein a metal pipe is used as the casing element (2) or wherein the casing element (2) is formed into a pipe after establishment of the connection to the capillary structure (3).

8. A heat pipe (1) comprising a casing element (2) and a coherent capillary structure (3) which is surrounded by the casing element (2), wherein the capillary structure (3) is connected to the casing element (2).

9. The heat pipe (1) according to claim 8, wherein the capillary structure (3) is a metal net or a metal mesh or a metal sponge or a metal wool or a metal foam.

10. The heat pipe (1) according to claim 8, wherein the capillary structure (3) is sintered to the casing element (2).

11. The heat pipe (1) according to claim 8, wherein the capillary structure (3) is arranged between the casing element (2) and the at least one spring element (8).

12. The heat pipe (1) according to claim 11, wherein the spring element (8) is a coil spring.
